(19) United States
(12) Patent Application Publication
(10) Pub. No.: US 2016/0088060 A1
(43) Pub. Date: Mar. 24, 2016

(54) GESTURE NAVIGATION FOR SECONDARY USER INTERFACE

(71) Applicant: Microsoft Technology Licensing, LLC, Redmond, WA (US)

(72) Inventors: Mohammed Kaleemur Rahman, Seattle, WA (US); Brian David Cross, Seattle, WA (US)

(73) Assignee: Microsoft Technology Licensing, LLC, Redmond, WA (US)

(21) Appl. No.: 14/495,122

(22) Filed: Sep. 24, 2014

(51) Int. Cl. H04L 29/08; G06F 3/0488

(52) U.S. Cl. CPC H04L 67/025; G06F 3/04883

(57) ABSTRACT

One or more techniques and/or systems are provided for gesture navigation for a secondary user interface. For example, a primary device (e.g., a smart phone) may establish a communication connection with a secondary device having a secondary display (e.g., a television). The primary device may project a rendering of a secondary user interface, of a secondary application executing on the primary device (e.g., a photo app), to the secondary display of the secondary device. The secondary user interface may comprise a user interface element (e.g., a photo carousel). The primary device may receive a continuous motion gesture input (e.g., a looping gesture on a touch display of the smart phone). The primary device may visually traverse, through the secondary user interface, one or more content items of the user interface element based upon the continuous motion gesture input (e.g., scroll through photos of the photo carousel).

### BACKGROUND

Many users may interact with various types of computing devices, such as laptops, tablets, personal computers, mobile phones, kiosks, videogame systems, etc. In an example, a user may utilize a mobile phone to obtain driving directions, through a map interface, to a destination. In another example, a user may utilize a store kiosk to print coupons and lookup inventory through a store user interface. Users may utilize keyboards, mice, touch input devices, cameras, and/or other input devices to interact with such computing devices.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for gesture navigation for a secondary user interface are provided herein. In an example, a primary device establishes a communication connection with a secondary device. The primary device projects a rendering of a secondary user interface, of a secondary application executing on the primary device, to a secondary display of the secondary device. The secondary user interface comprises a user interface element. The primary device receives a continuous motion gesture input through a primary input sensor associated with the primary device. For example, a virtual touch pad, through which the continuous motion gesture input may be received, may be populated within a primary user interface displayed on a primary display of the primary device. The primary device visually traverses, through the secondary user interface, one or more content items of the user interface element based upon the continuous motion gesture input.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of gesture navigation for a secondary user interface.

FIG. 2A is a component block diagram illustrating an exemplary system for gesture navigation for a secondary user interface.

FIG. 2B is a component block diagram illustrating an exemplary system for gesture navigation for a secondary user interface, where a rendering of a secondary user interface is projected to a secondary display.

FIG. 2C is a component block diagram illustrating an exemplary system for gesture navigation for a secondary user interface, where content items of a user interface element are visually traversed.

FIG. 2D is a component block diagram illustrating an exemplary system for gesture navigation for a secondary user interface, where content items of a user interface element are visually traversed.

FIG. 2E is a component block diagram illustrating an exemplary system for gesture navigation for a secondary user interface, where a content item is activated.

FIG. 2F is a component block diagram illustrating an exemplary system for gesture navigation for a secondary user interface, where a back command is implemented.

FIG. 3 is a component block diagram illustrating an exemplary system for gesture navigation for a secondary user interface, where a user interface element is located.

FIG. 4 is a component block diagram illustrating an exemplary system for gesture navigation for a secondary user interface.

FIG. 5 is a component block diagram illustrating an exemplary system for gesture navigation for a secondary user interface.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for gesture navigation for a secondary user interface are provided herein. A user may desire to project an application executing on a primary device (e.g., a smart phone) to a secondary device (e.g., a television), such that an application interface, of the application, is displayed on a secondary display of the secondary device according to device characteristics of the secondary device (e.g., matching an aspect ratio of a television display of the television). Because the application is executing on the primary device but is displayed on a secondary display of the secondary device, the user may interact with the primary device (e.g., touch gestures on the smart phone) to interact with user interface elements of the application interface since the primary device is driving the secondary display. Accordingly, as provided herein, a continuous motion gesture input, received through a primary input sensor associated with the primary display (e.g., a circular finger gesture on an input user interface surface, such as a virtualized touch pad, displayed by the smart phone), may be used to visually traverse one or more content items of a user interface element of the secondary user interface (e.g., the user may scroll through images of an image carousel of the secondary user interface that is projected to the television display). In this way, the user may scroll through content items of a user interface element displayed on the secondary display using continuous motion gesture input on the primary device. Because the continuous motion gesture input may be used to traverse one or more content items (e.g., the circular finger gesture may be an analog input where each loop is translated into a single scroll of an image, and thus 10 continuous loops may result in the user scrolling through 10 images), the user may not be encumbered with having to perform multiple separate flick gestures (e.g., 10 separate flick gestures) that would otherwise be used to navigate between content items. Thus, simple continuous gestures on the primary device may impact renderings of the secondary user interface projected from the primary device (e.g., the smart phone) to the secondary device (e.g., the television).

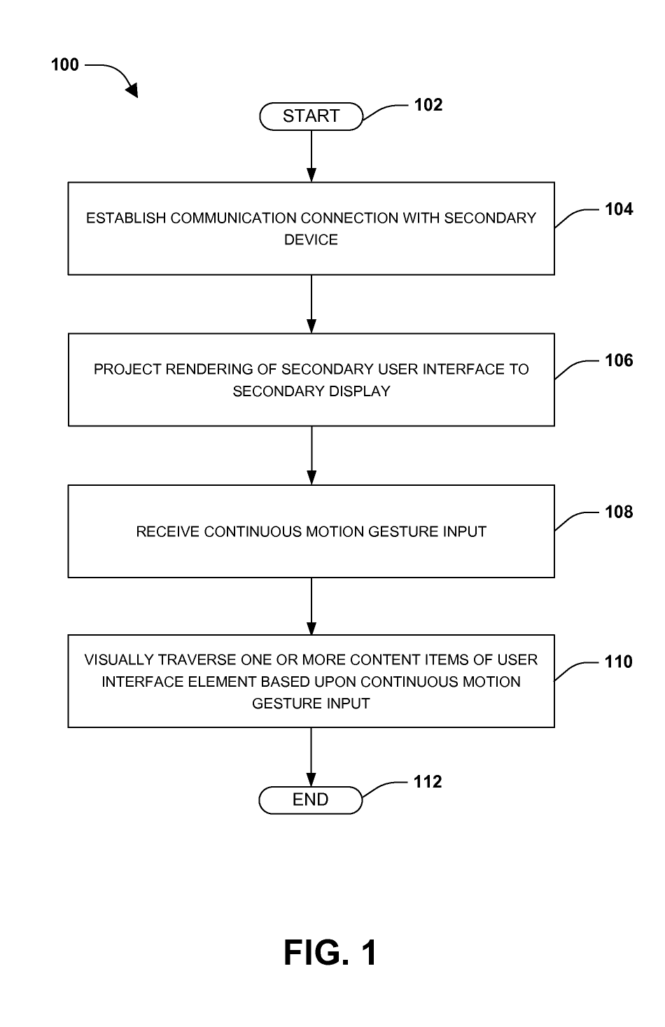

An embodiment of gesture navigation for a secondary user interface is illustrated by an exemplary method 100 of FIG. 1. At 102, the method starts. At 104, a primary device may establish a communication connection with a secondary device. The primary device (e.g., a smart phone, a tablet, etc.) may be configured to locally support execution of a secondary application, such as a photo app installed on the primary device. The secondary device (e.g., an appliance such as a refrigerator, a television, an audio visual device, a vehicle device, a wearable device such as a smart watch or glasses, a laptop, a personal computer, etc.) may not locally support execution of the secondary application (e.g., the photo app may not be installed on the secondary device). In an example, the communication connection may be a wireless communication channel (e.g., Bluetooth). In an example, a user may walk past a television secondary device while holding a smart phone primary device, and thus the communication connection may be established (e.g., automatically, programmatically, etc.). In an example, the user may (e.g., manually) initiate the communication connection.

At 106, a rendering of a secondary user interface, of the secondary application executing on the primary device, may be projected from the primary device to a secondary display of the secondary device. The secondary user interface comprises a user interface element. For example, the smart phone primary device may be executing the photo app. The smart phone primary device may generate renderings of a photo app user interface comprising a title user interface element, a photo carousel user interface element, a search text entry box user interface element, and/or other user interface elements. The smart phone primary device may drive a television display of the television secondary device by providing the renderings to the television secondary device for display on the television display. In this way, the smart phone primary device may project the renderings of the photo app user interface to the television display by providing the renderings to the television secondary device for display on the television display.

In an example, a primary user interface is displayed on a primary display of the primary device. For example, an email application hosted by a mobile operating system of the smart phone primary device may be displayed on a smart phone display. In an example, the primary user interface is different than the secondary user interface (e.g., the primary user interface corresponds to the email application, while the secondary user interface corresponds to the photo app). In an example, the secondary user interface is not displayed on the primary display and/or the primary user interface is not displayed on the secondary display (e.g., the secondary user interface is not a mirror of what is displayed on the primary display). In an example, the primary user interface may be populated with an input user interface surface, such as a virtualized touch pad, through which the user may provide input, such as a continuous motion gesture input, that may be used as input for the secondary application projected through the secondary display as the secondary user interface.

At 108, a continuous motion gesture input may be received by the primary device through a primary input sensor associated with the primary device (e.g., a camera input sensor that detects a visual gesture or body gesture such as the user moving a hand or arm in a circular motion; the virtualized touch pad; a motion sensor, compass, a wrist sensor, and/or gyroscope that may detect the user moving the smart phone primary device in a circular motion; a touch sensor such as a touch enabled display of the smart phone primary device; etc.). For example, the user may draw an at least partially continuous shape (e.g., a circle, a square, a polygon, or any other loop type of gesture) on the virtualized touch pad (e.g., using a finger). In this way, the continuous motion gesture input may comprise a circular gesture, a loop gesture, a touch gesture, a primary device movement gesture, a visual gesture captured by a camera input sensor, etc. In an example, the continuous motion gesture may comprise a first touch input and a second touch input. The second touch input may be concurrent with the first touch input (e.g., a two finger swipe, a pinch, etc.). In an example, the continuous motion gesture may comprise a first anchor touch input and a second motion touch input (e.g., the user may hold a first finger on the virtualized touch pad as an anchor, and may swipe a second finger in a circular motion around the first finger). It may be appreciated that a variety of input may be detected as the continuous motion gesture input.

At 110, one or more content items of the user interface element may be traversed based upon the continuous motion gesture input. For example, photos, of the photo carousel user interface element within the photo app user interface that is displayed on the television display, may be traversed (e.g., scrolled between such that photos are brought into and then out of focus for the photo carousel user interface element). In this way, user input on the primary device may be used to traverse content items associated with the secondary application that is executing on the primary device and projected to the secondary display of the secondary device. The continuous motion gesture input may allow the user to traverse, such as scroll between, multiple content items with a single continuous gesture (e.g., a single looping gesture may be used as analog input to scroll between any number of photos), as opposed to other gestures such as flick gestures that may require separate flick gestures for each content item traversal (e.g., 10 flick gestures to scroll between 10 photos).

In an example, the continuous motion gesture input may be received while no traversable user interface elements of the secondary user interface are selected, but a user interface element may nevertheless be traversed. For example, a user intent may be determined and a corresponding user interface element may be selected for traversal. For example, because the photo carousel user interface element may be the only user interface element that may be traversable, because the photo carousel user interface element was the last user interface element with which the user interacted, because the photo carousel user interface element is the nearest user interface element to a current cursor location, etc. the user intent may be determined as corresponding to the photo carousel user interface element, as opposed to the title user interface element, the search text entry box user interface element, and/or other user interface elements. Accordingly, the photo carousel user interface element may be selected for traversal based upon the user intent.

In an example, the content items may be visually traversed at a traversal speed that is relative to a speed of the continuous motion gesture input, and thus the speed of the looping gesture may influence the speed of scrolling between content items). For example, the traversal speed may be increased or decreased based upon an increase or decrease in the speed of the continuous motion gesture input, thus providing the user with control over how quickly the user scrolls through photos of the photo carousel user interface element, for example.

In an example, the continuous motion gesture input comprises a first touch input (e.g., a first finger gesture) and a second touch input (e.g., a second finger gesture). The second touch input may be concurrent with the first touch input. The primary device may control a first traversal aspect of the visual traversal based upon the first touch input (e.g., a scroll direction). The primary device may control a second traversal aspect of the visual traversal based upon the second touch input (e.g., a zooming aspect for the photos).

In an example, the continuous motion gesture input comprises a first anchor touch input (e.g., the user may hold a first finger onto the smart phone display) and a second motion touch input (e.g., the user may loop around the first finger with a second finger). The one or more content items may be visually traversed based upon the second motion touch input and based upon a distance between a first anchor touch input location of the first anchor touch input and a second motion touch input location of the second motion touch input (e.g., the photos may be traversed in a direction corresponding to the second motion touch input and at a traversal speed corresponding to the distance between the first anchor touch input location and the second motion touch input location).

In an example, the continuous motion gesture input comprises a first touch input and a second touch input that is concurrent with the first touch input. The first touch input may be mapped as a first input to the user interface element for controlling the visual traversal of the one or more content items. The second touch input may be mapped as a second input to a second user interface element (e.g., a scrollable photo album selection list user interface element). In this way, the user may concurrently control multiple user interface elements (e.g., the first touch input may be used to scroll photos of the photo carousel user interface element and the second touch input may be used to scroll albums of the scrollable photo album selection list).

In an example, an activate input (e.g., a touch gesture, such as a tap input, double tap input, etc., on the virtualized touch pad) may be received through the primary input sensor. A current content item, on the secondary display, upon which the user interface element is focused may become activated. For example, the user may scroll through the photo carousel user interface element until a beach vacation photo is brought into focus. The user may use a tap gesture to open the beach vacation photo into a full screen viewing mode (e.g., the photo app user interface may be transitioned into the full screen viewing mode of the beach vacation photo). In an example, an entry may be created within a back stack (e.g., a back stack maintained by a mobile operating system of the smart phone primary device, and used to navigate back to previous states of user interfaces) based upon the secondary user interface transitioning into a new state based upon the activation (e.g., based upon the photo app user interface transitioning into the full screen viewing mode). The entry may specify that the current content item was in focus during a prior state of the secondary user interface before the activation (e.g., that the beach vacation photo was in focus for the photo carousel user interface element prior to the photo app user interface transitioning into the full screen viewing mode). Responsive to receiving a back command input, the secondary user interface may be transitioned from the new state to the prior state with the current content item being brought into focus based upon the entry within the back stack. In this way, the user may navigate between various states of the secondary user interface. At 112, the method ends.

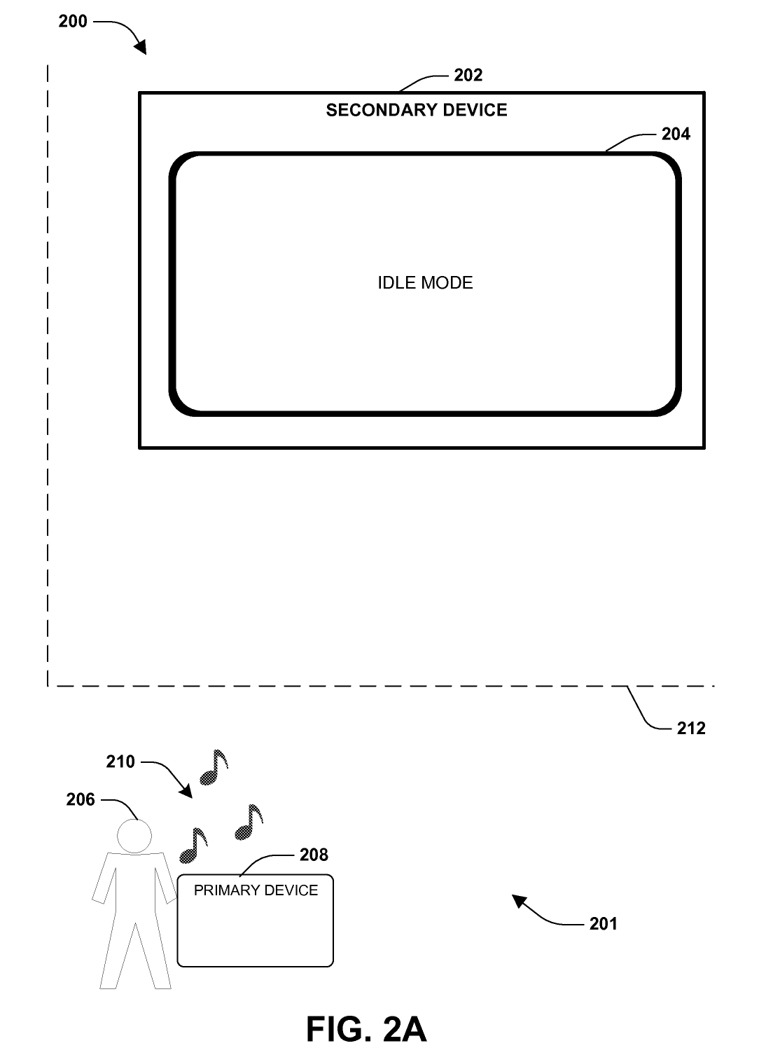

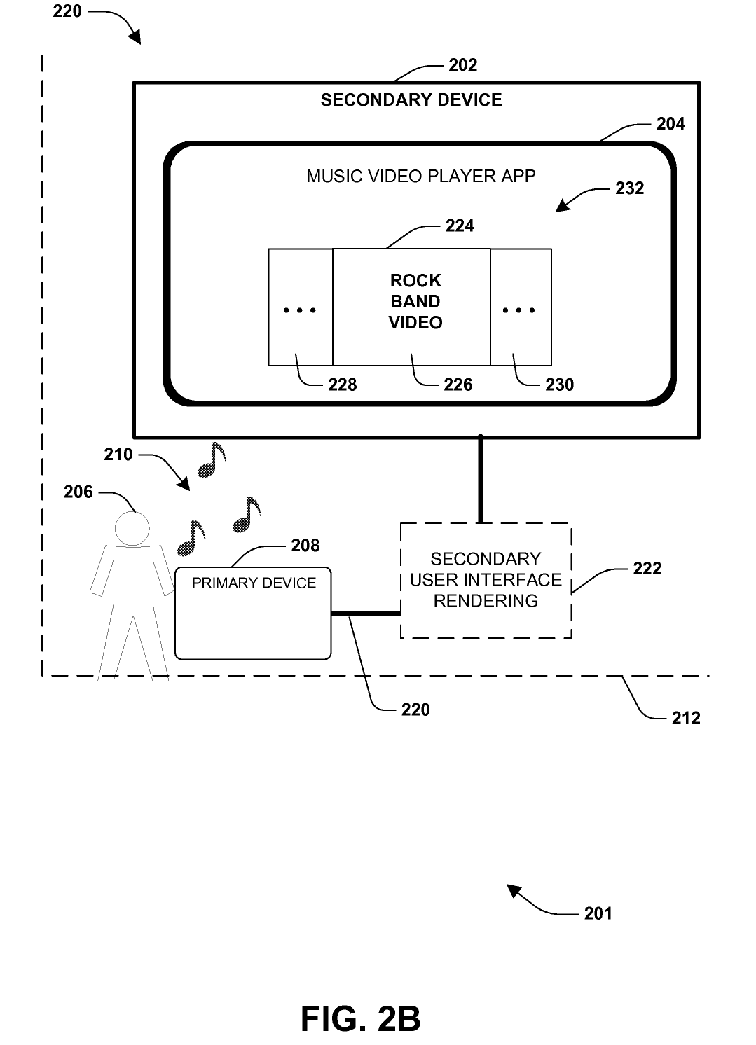

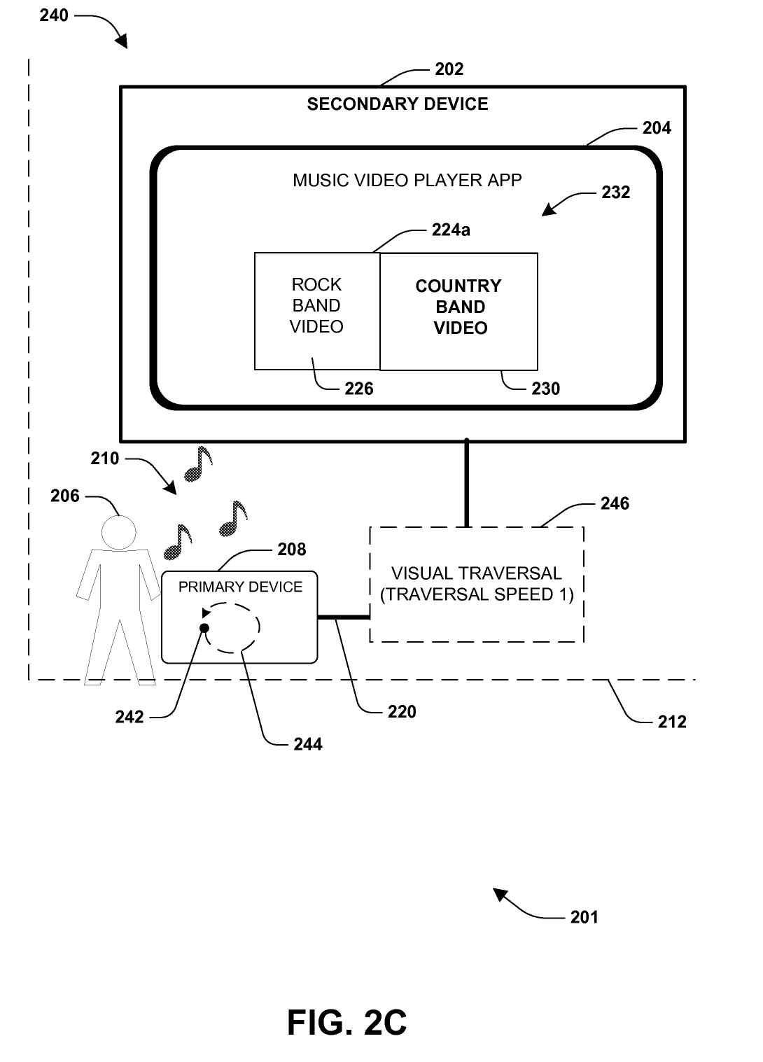

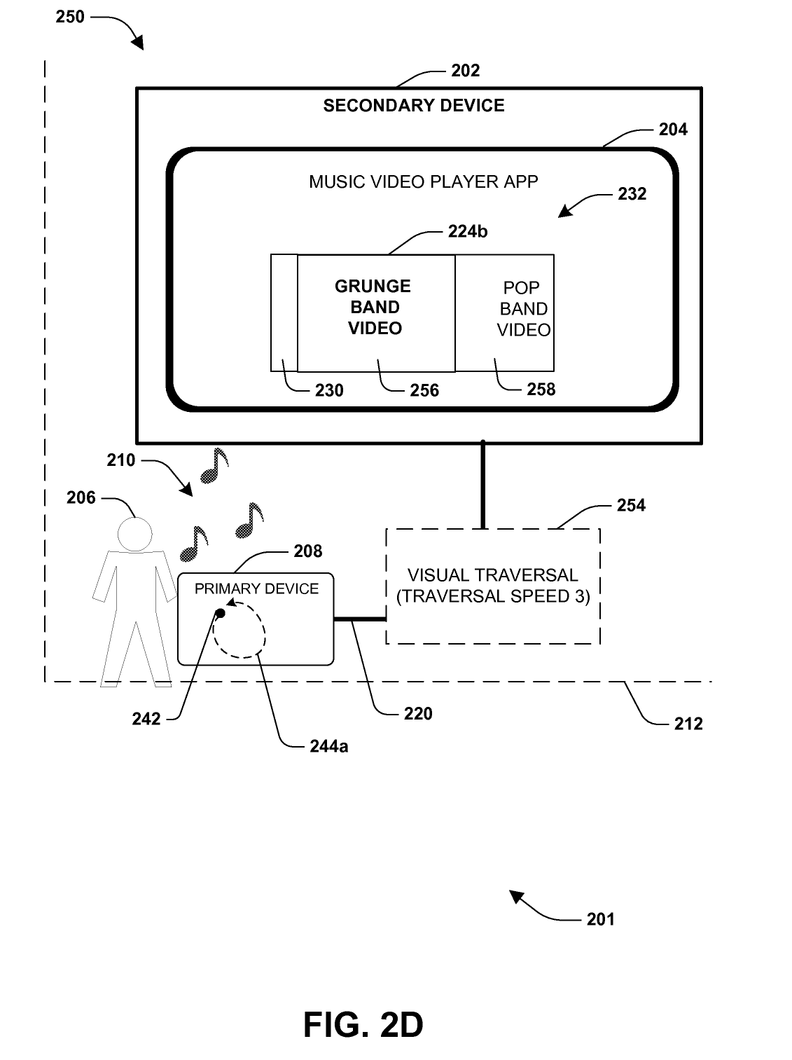

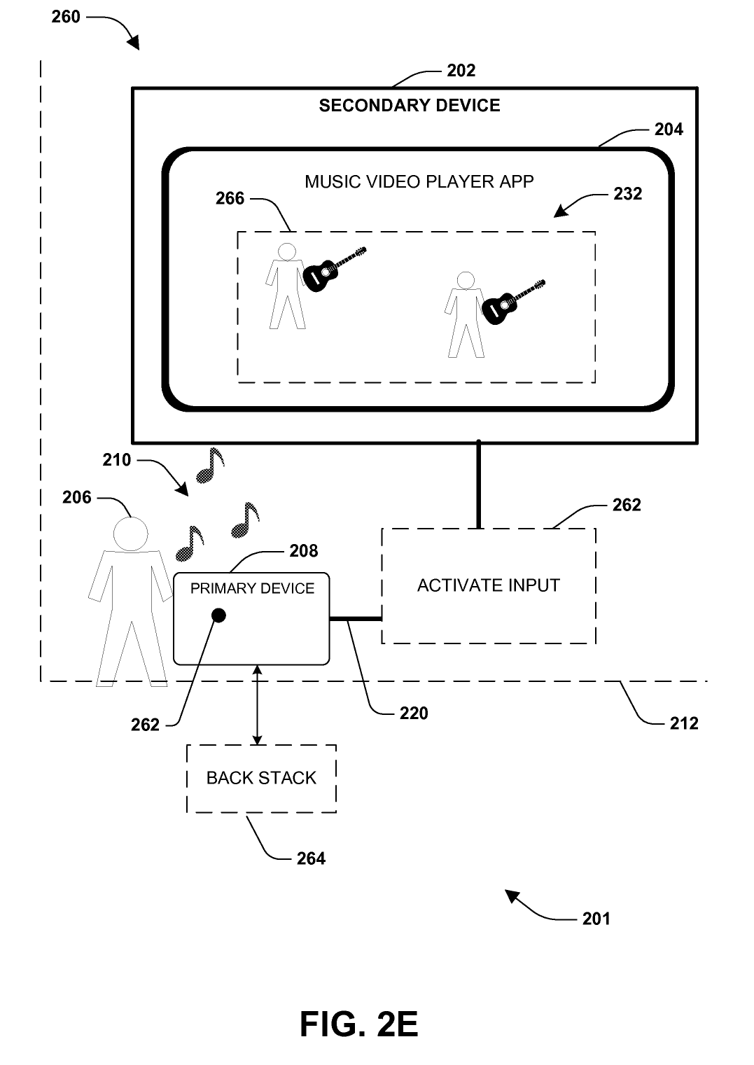

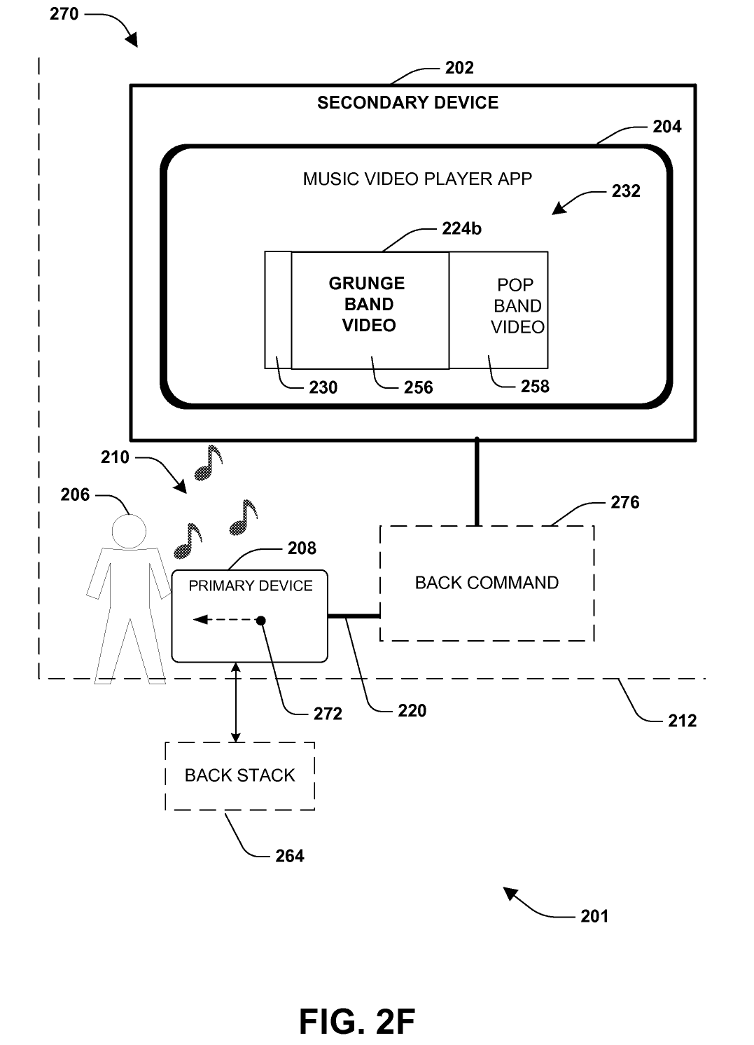

FIGS. 2A-2F illustrate examples of a system 201, comprising a primary device 208, for gesture navigation for a secondary user interface. FIG. 2A illustrates an example 200 of a user 206 listening to a Rock Band song 210 on the primary device 208 (e.g., a smart phone primary device). The primary device 208 may be greater than a threshold distance 212 from a secondary device 202 comprising a secondary display 204 (e.g., a television secondary device) that is in an idle mode. FIG. 2B illustrates an example 220 of a projection triggering event triggering based upon the primary device 208 being within the threshold distance 212 from the secondary device 202. The primary device 208 may establish a communication connection 220 with the secondary device 202. A music video player app, installed on the primary device 208, may be executed to provide music video viewing functionality (e.g., for a video of the Rock Band song 210). Accordingly, the primary device 208 may utilize a primary processor, primary memory, and/or other resources of the primary device 208 to execute the music video player app to create a music video player app user interface 232 for projection to the secondary display 204 of the secondary device 202. The primary device 208 may project a rendering 222 of the music video player app user interface 232 to the secondary display 204 (e.g., the primary device 208 may locally generate the rendering 222, and may send the rendering 222 over the communication connection 220 to the secondary device 202 for display on the secondary display 204). In this way, the primary device 208 may drive the secondary display 204. In an example, the music video player app user interface 232 is not displayed on the primary device 208.

The music video player app user interface 232 may comprise one or more user interface elements, such as a video selection carousel user interface element 224. The video selection carousel user interface element 224 may comprise one or more content items that may be traversable, such as scrollable. For example, the video selection carousel user interface element 224 may comprise a heavy metal band video 228, a rock band video 226, a country band video 230, and/or other video content items available for play through the music video player app.

FIG. 2C illustrates an example 240 of the primary device 208 receiving a continuous motion gesture input 244 (e.g., the user 206 may use a finger 242 to perform a looping gesture, such as a first loop). The primary device 208 may visually traverse 246, through the music video player app user interface 232, the one or more video content items of the video selection carousel user interface element 224 based upon the continuous motion gesture input 244. For example, the heavy metal band video 228 may be scrolled to the left out of view from the music video player app user interface 232, the rock band video 226 may be scrolled to the left out of focus, and the country band video 230 may be scrolled to the left into focus at a traversal speed of 1 out of 5 based upon the continuous motion gesture input 244 (e.g., the user may slowly perform the looping gesture), resulting in a first updated video selection carousel user interface element 224a. In an example, the primary device 208 may project a rendering of the first updated video selection carousel user interface element 224a to the secondary display 204.

FIG. 2D illustrates an example 250 of the primary device 208 continuing to receive the continuous motion gesture input 244a (e.g., the user 206 may continue to perform the looping gesture, such as performing a second loop, using the finger 242). The primary device 208 may continue to visually traverse 254, through the music video player app user interface 232, the one or more video content items of the first updated video selection carousel user interface element 224a based upon the user continuing to perform the continuous motion gesture input 244a. For example, the rock band video 226 may be scrolled to the left out of view from the music video player app user interface 232, the country band video 230 may be scrolled to the left out of focus, a grunge band video 256 may be scrolled to the left into focus, and a pop band video 258 may be scrolled to the left into view at a traversal speed of 3 out of 5 based upon the continuous motion gesture input 244a (e.g., the user 206 may perform the looping gesture at a faster rate of speed), resulting in a second updated video selection carousel user interface element 224b. In an example, the primary device 208 may project a rendering of the second updated video selection carousel user interface element 224b to the secondary display 204.

FIG. 2E illustrates an example 260 of the primary device 208 activating a content item based upon receiving activate input 262. For example, a first state of the music video player app user interface 232 may comprise the grunge band video 256 being in focus for the second updated video selection carousel user interface element 224b (e.g., example 250 of FIG. 2D). While the grunge band video 256 is in focus, the user 206 may tap the primary device 208 (e.g., tap a touch screen of the smart phone primary device), which may be received by the primary device 208 as activate input 262. The primary device 208 may implement the activate input 262 by invoking the music video player app, executing on the primary device 208, to play the grunge band video 256 through a video playback user interface element 266. In an example, the primary device 208 may project a rendering of the video playback user interface element 266 to the secondary display 204. In this way, a new state of the music video player app user interface 232 may comprise the video playback user interface element 266 playing the grunge band video 256. In an example, the primary device 208 may create an entry within a back stack 264 (e.g., a back stack maintained by a mobile operating system of the smart phone primary device, and used to navigate back to previous states of user interfaces). The entry may specify that the grunge band video 256 was in focus during the first state (e.g., a prior state) of the music video player app user interface 232 before the activation of the grunge band video 256.

FIG. 2F illustrates an example 270 of the primary device 208 implementing a back command 276 utilizing the entry within the back stack 264. For example, the user 206 may perform a back command gesture 272 while watching the grunge band video 256 through the video playback user interface element 266. The primary device 208 may query the back stack 264 to identify the entry specifying that the grunge band video 256 was in focus during the first state (e.g., the prior state) of the music video player app user interface 232 before the activation of the grunge band video 256. Accordingly, the primary device 208 may transition the music video player app user interface 232 to the first state where the grunge band video 256 is in focus for the second updated video selection carousel user interface element 224b. In an example, the primary device 208 may project a rendering of the second updated video selection carousel user interface element 224b to the secondary display 204.

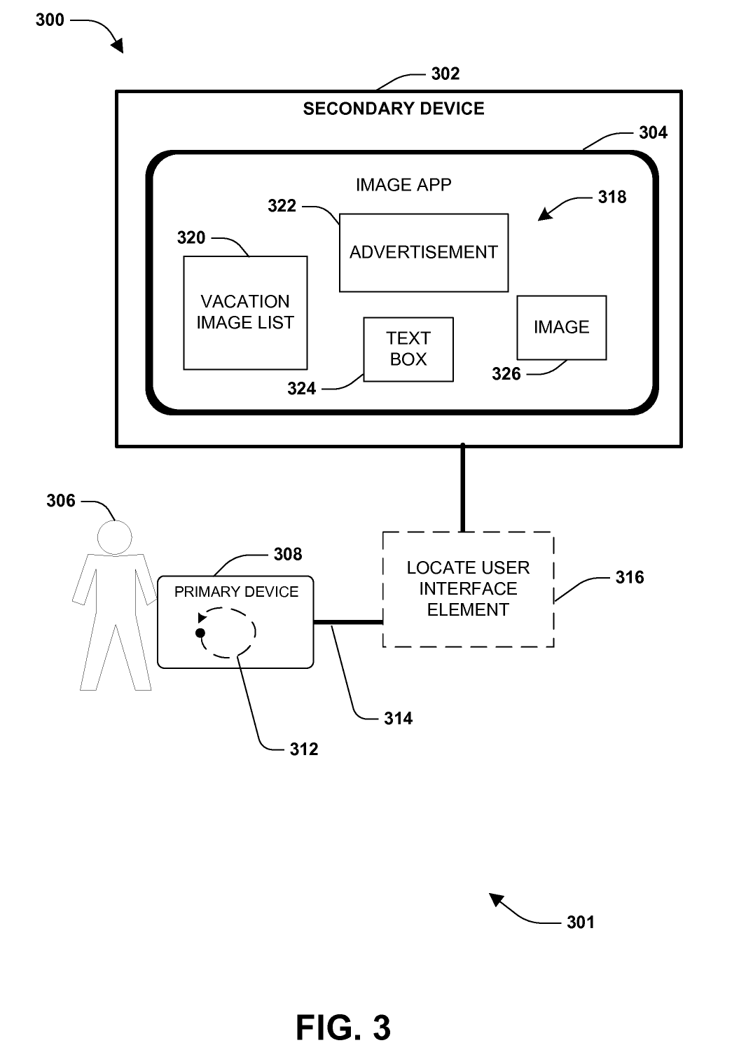

FIG. 3 illustrates an example 300 of a system 301 for gesture navigation for a secondary user interface. A primary device 308 may establish a communication connection 314 with a secondary device 302. The primary device 308 may be configured to locally support execution of a secondary application, such as an image app installed on the primary device 308. The secondary device 302 may not locally support execution of the secondary application (e.g., the image app may not be installed on the secondary device 302). The primary device 308 may project a rendering of an image app user interface 318, of the image app executing on the primary device 308, to a secondary display 304 of the secondary device 302. The image app user interface 318 may comprise a vacation image list user interface element 320, an advertisement user interface element 322, a text box user interface element 324, an image user interface element 326, and/or other user interface elements.

The primary device 308 may receive a continuous motion gesture input 312 through a primary input sensor associated with the primary device 308 (e.g., a circular hand gesture detected by a camera input sensor). The continuous motion gesture input 312 may be received while no traversable user interface elements of the image app user interface 318 are selected. Accordingly, the primary device 308 may locate 316 a user interface element for traversal. For example, the primary device 308 may determine a user intent corresponding to a traversal of the vacation image list 320 (e.g., because the vacation image list 320 may be the last user interface element with which the user 306 interacted). The primary device 308 may select the vacation image list user interface element 320 for traversal based upon the user intent. In this way, the user 306 may traverse through vacation images within the vacation image list user interface element 320 based upon the continuous motion gesture input 312.

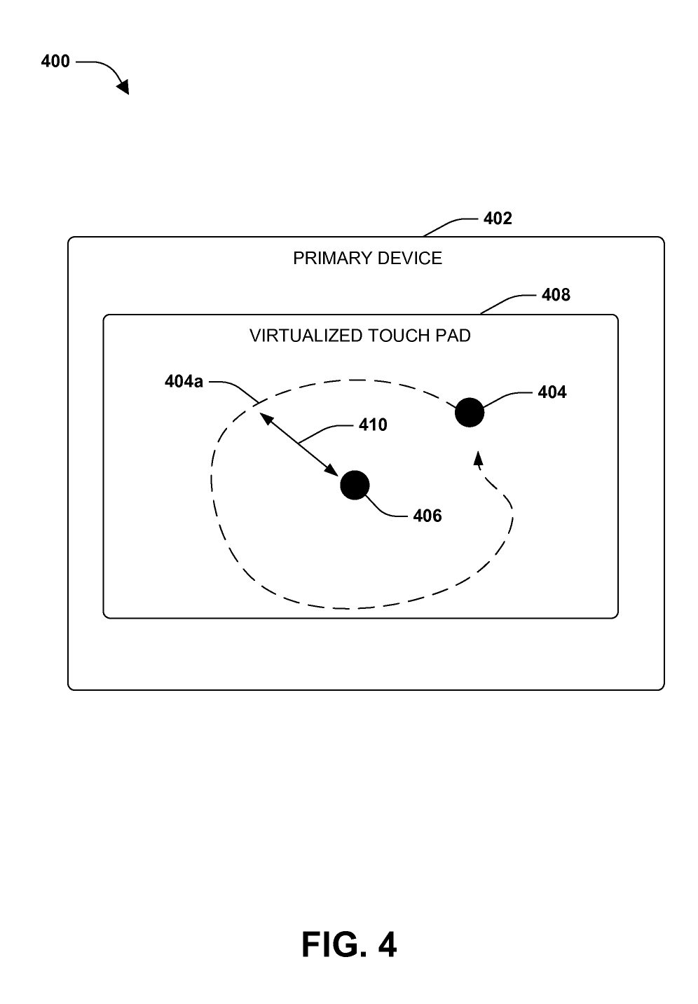

FIG. 4 illustrates an example of a system 400 comprising a primary device 402 (e.g., a tablet primary device) displaying a virtualized touch pad 408 through which a user can interact with a secondary user interface, of a secondary application executing on the primary device (e.g., an image app), that is projected to a secondary display of a secondary device (e.g., a television). For example, a continuous motion gesture input may be received through the virtualized touch pad 408. The continuous motion gesture input comprises a first anchor touch input 406 (e.g., the user may hold a first finger at a first anchor touch input location of the first anchor touch input 406) and a second motion touch input 404 (e.g., the user may loop a second finger around the first anchor touch input location at a distance 410 between the first anchor touch input location and a second motion touch input location 404a of the second motion touch input 404). The primary device 402 may visually traverse one or more content items of a user interface element of the secondary user interface (e.g., scroll through images of an image carousel user interface element of the image app) based upon the second motion touch input (e.g., corresponding to a scroll direction and traversal speed between the images within the image carousel user interface element) and/or based upon the distance 410 (e.g., corresponding to a zoom level for the images, such as a zoom in for an image as the distance 410 decreases and a zoom out for the image as the distance 410 increases). In this way, the user may navigate through and/or otherwise interact with the image app, displayed on the secondary display, using continuous motion gesture input on the virtualized touch pad 408 of the primary device 402.

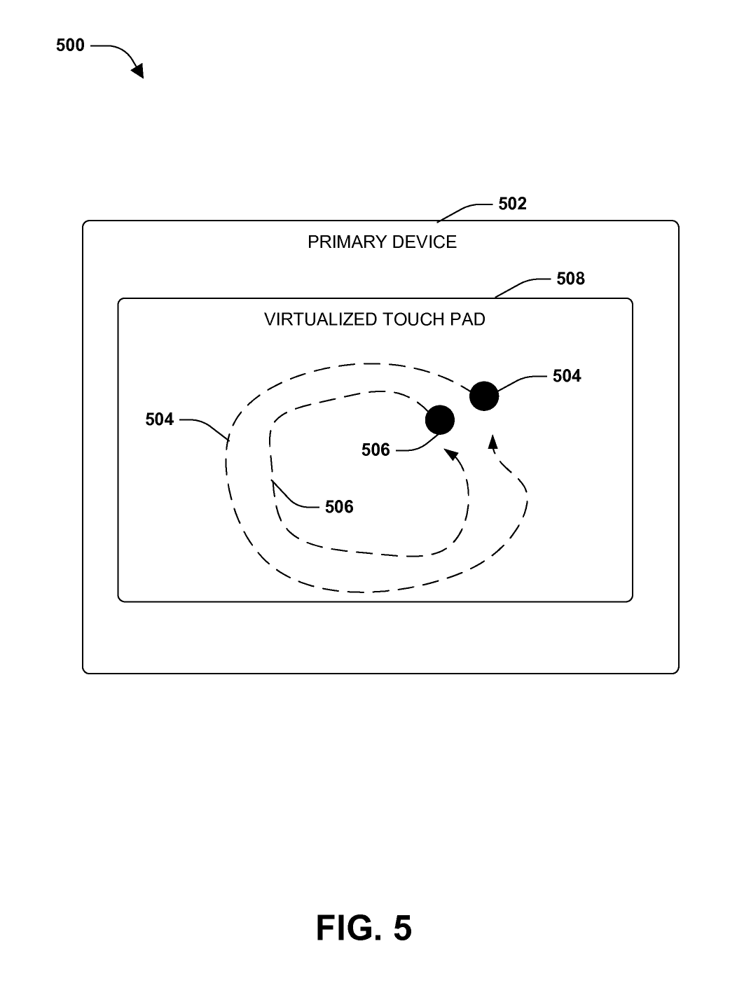

FIG. 5 illustrates an example of a system 500 comprising a primary device 502 (e.g., a tablet primary device) displaying a virtualized touch pad 508 through which a user can interact with a secondary user interface, of a secondary application executing on the primary device (e.g., a music app), that is projected to a secondary display of a secondary device (e.g., a television). For example, a continuous motion gesture input may be received through the virtualized touch pad 508. The continuous motion gesture input comprises a first touch input 506 (e.g., the user may move a first finger according to a first looping gesture) and a second touch input 504 (e.g., the user may move a second finger according a second looping gesture). The primary device 502 may visually traverse one or more content items of a user interface element of the secondary user interface (e.g., scroll through volume settings) based upon the first touch input 506 and the second touch input 504. For example, the volume settings may be traversed at an increased traversal speed because the continuous motion gesture input comprises both the first touch input 506 and the second touch input 504, as opposed to merely a single touch input that may otherwise result in a relatively slower traversal of the volume settings. In this way, the user may navigate through and/or otherwise interact with the music app, displayed on the secondary display, using continuous motion gesture input on the virtualized touch pad 508.

According to an aspect of the instant disclosure, a system for gesture navigation for a secondary user interface is provided. The system includes a primary device. The primary device is configured to establish a communication connection with a secondary device. The primary device is configured to project a rendering of a secondary user interface, of a secondary application executing on the primary device, to a secondary display of the secondary device. The secondary user interface comprises a user interface element. The primary device is configured to receive a continuous motion gesture input through a primary input sensor associated with the primary device. The primary device is configured to visually traverse, through the secondary user interface, one or more content items of the user interface element based upon the continuous motion gesture input.

According to an aspect of the instant disclosure, a method for gesture navigation for a secondary user interface is provided. The method includes establishing a communication connection between a primary device and a secondary device. The method includes projecting, by the primary device, a rendering of a secondary user interface, of a secondary application executing on the primary device, to a secondary display of the secondary device. The secondary user interface comprises a user interface element. The method includes receiving, by the primary device, a continuous motion gesture input through a primary input sensor associated with the primary device. The method includes visually traversing, by the primary device, through the secondary user interface, one or more content items of the user interface element based upon the continuous motion gesture input.

According to an aspect of the instant disclosure, a computer readable medium comprising instructions which when executed perform a method for gesture navigation for a secondary user interface is provided. The method includes displaying a primary user interface on a primary display of a primary device. The method includes establishing a communication connection between the primary device and a secondary device. The method includes projecting, by the primary device, a rendering of a secondary user interface, of a secondary application executing on the primary device, to a secondary display of the secondary device. The secondary user interface comprises a user interface element, where the secondary user interface is different than the primary user interface. The method includes populating, by the primary device, the primary user interface with an input user interface surface. The method includes receiving, by the primary device, a continuous motion gesture input through the input user interface surface. The method includes visually traversing, by the primary device, through the secondary user interface, one or more content items of the user interface element based upon the continuous motion gesture input.

According to an aspect of the instant disclosure, a means for gesture navigation for a secondary user interface is provided. A communication connection between a primary device and a secondary device is established, by the means for gesture navigation. A rendering of a secondary user interface, of a secondary application executing on the primary device, is projected to a secondary display of the secondary device, by the means for gesture navigation. The secondary user interface comprises a user interface element. A continuous motion gesture input is received through a primary input sensor associated with the primary device, by the means for gesture navigation. One or more content items of the user interface element are visually traversed based upon the continuous motion gesture input, by the means for gesture navigation.

According to an aspect of the instant disclosure, a means for gesture navigation for a secondary user interface is provided. A primary user interface is displayed on a primary display of a primary device, by the means for gesture navigation. A communication connection between the primary device and a secondary device is established, by the means for gesture navigation. A rendering of a secondary user interface, of a secondary application executing on the primary device, is project to a secondary display of the secondary device, by the means for gesture navigation. The secondary user interface comprises a user interface element, where the secondary user interface is different than the primary user interface. The primary user interface is populated with an input user interface surface, by the means for gesture navigation. A continuous motion gesture input is received through the input user interface surface, by the means for gesture navigation. One or more content items of the user interface element are visually traversed based upon the continuous motion gesture input, by the means for gesture navigation.

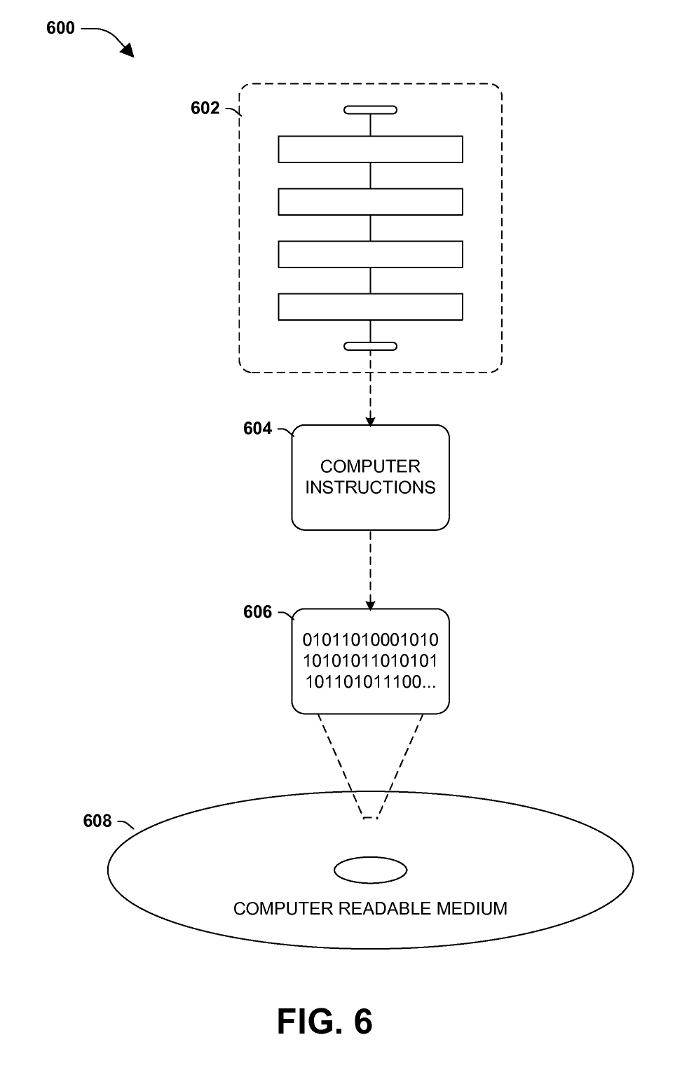

Still another embodiment involves a computer-readable medium comprising processor-executable instructions configured to implement one or more of the techniques presented herein. An example embodiment of a computer-readable medium or a computer-readable device is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1, for example. In some embodiments, the processor-executable instructions 604 are configured to implement a system, such as at least some of the exemplary system 201 of FIGS. 2A-2F, at least some of the exemplary system 301 of FIG. 3, at least some of the exemplary system 400 of FIG. 4, and/or at least some of the exemplary system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

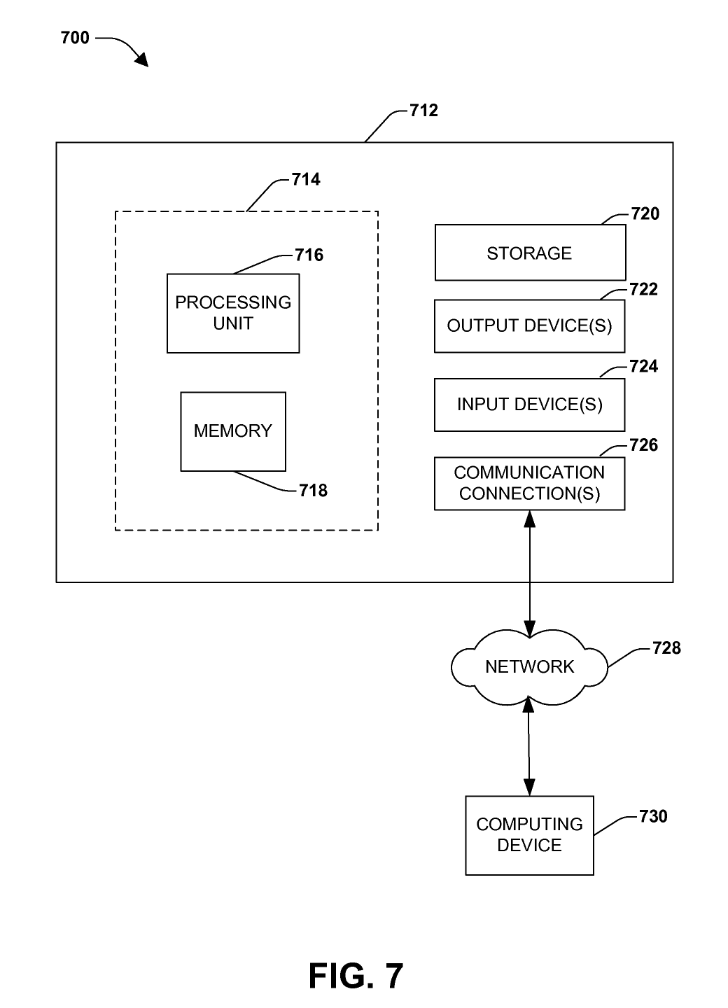

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Computer storage media does not, however, include propagated signals. Rather, computer storage media excludes propagated signals. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for gesture navigation for a secondary user interface, comprising:
a primary device configured to:
establish a communication connection with a secondary device;
project a rendering of a secondary user interface, of a secondary application executing on the primary device, to a secondary display of the secondary device, the secondary user interface comprising a user interface element;
receive a continuous motion gesture input through a primary input sensor associated with the primary device; and
visually traverse, through the secondary user interface, one or more content items of the user interface element based upon the continuous motion gesture input.

2. The system of claim 1, the primary device configured to:
display a primary user interface on a primary display of the primary device, the primary user interface different than the secondary user interface.

3. The system of claim 2, the primary user interface associated with a primary application different than the secondary application.

4. The system of claim 2, the secondary user interface not displayed on the primary display and the primary user interface not displayed on the secondary display.

5. The system of claim 1, the primary device configured to:
visually traverse the one or more content items at a traversal speed relative to a speed of the continuous motion gesture input.

6. The system of claim 5, the primary device configured to:
increase the traversal speed based upon detecting an increase in the speed of the continuous motion gesture input.

7. The system of claim 5, the primary device configured to:
decrease the traversal speed based upon detecting an decrease in the speed of the continuous motion gesture input.

8. The system of claim 1, the continuous motion gesture input comprising at least one of a circular gesture, a loop gesture, a touch gesture, a primary device movement gesture, a visual gesture captured by a camera input sensor, or a body gesture captured by at least one of the camera input sensor, a motion detection sensor, or a wrist sensor.

9. The system of claim 1, the primary device configured to:
responsive to receiving an activate input through the primary input sensor, activating a current content item, on the secondary display, upon which the user interface element is focused.

10. The system of claim 9, the primary device configured to:
create an entry within a back stack based upon the secondary user interface transitioning into a new state based upon the activation, the entry specifying that the current content item was in focus during a prior state of the secondary user interface before the activation; and
responsive to receiving a back command input, transitioning the secondary user interface from the new state to the prior state with the current content item being brought into focus based upon the entry within the back stack.

11. The system of claim 1, the continuous motion gesture input comprising a first anchor touch input and a second motion touch input, and the primary device configured to:
visually traverse the one or more content items based upon the second motion touch input and a distance between a first anchor touch input location of the first anchor touch input and a second motion touch input location of the second motion touch input.

12. The system of claim 1, the continuous motion gesture input comprising a first touch input and a second touch input that is concurrent with the first touch input, and the primary device configured to:
control a first traversal aspect of the visual traversal of the one or more content items based upon the first touch input; and
control a second traversal aspect of the visual traversal of the one or more content items based upon the second touch input.

13. The system of claim 1, the continuous motion gesture input comprising a first touch input and a second touch input that is concurrent with the first touch input, and the primary device configured to:
map the first touch input as a first input to the user interface element for controlling the visual traversal of the one or more content items; and
map the second touch input as a second input to a second user interface element.

14. The system of claim 1, the primary device configured to:
display a primary user interface on a primary display of the primary device; and
populate the primary user interface with an input user interface surface through which the continuous motion gesture input is received.

15. The system of claim 1, the primary device configured to:
responsive to receiving the continuous motion gesture input while no traversable user interface elements of the secondary user interface are selected:
determine a user intent corresponding to a traversal of the user interface element; and
select the user interface element for traversal based upon the user intent.

16. A method for gesture navigation for a secondary user interface, comprising:
establishing a communication connection between a primary device and a secondary device;
projecting, by the primary device, a rendering of a secondary user interface, of a secondary application executing on the primary device, to a secondary display of the secondary device, the secondary user interface comprising a user interface element;
receiving, by the primary device, a continuous motion gesture input through a primary input sensor associated with the primary device; and
visually traversing, by the primary device, through the secondary user interface, one or more content items of the user interface element based upon the continuous motion gesture input.

17. The method of claim 16, comprising:
responsive to receiving an activate input through the primary input sensor, activating a current content item upon which the user interface element is focused.

18. The method of claim 16, the visually traversing comprising:
visually traversing the one or more content items at a traversal speed relative to a speed of the continuous motion gesture input.

19. The method of claim 18, comprising at least one of:
increasing the traversal speed based upon detecting an increase in the speed of the continuous motion gesture input; or
decreasing the traversal speed based upon detecting an decrease in the speed of the continuous motion gesture input.

20. A computer readable medium comprising instructions which when executed perform a method for gesture navigation for a secondary user interface, comprising:
displaying a primary user interface on a primary display of a primary device;
establishing a communication connection between the primary device and a secondary device;
projecting, by the primary device, a rendering of a secondary user interface, of a secondary application executing on the primary device, to a secondary display of the secondary device, the secondary user interface comprising a user interface element, the secondary user interface different than the primary user interface;
populating, by the primary device, the primary user interface with an input user interface surface;
receiving, by the primary device, a continuous motion gesture input through the input user interface surface; and
visually traversing, by the primary device, through the secondary user interface, one or more content items of the user interface element based upon the continuous motion gesture input.
